(19) United States
(12) Patent Application Publication
(10) Pub. No.: US 2026/0310599 A1
(43) Pub. Date: Oct. 8, 2026

(54) MEMORY BUFFER FOR BANDWIDTH-CRITICAL DATA

(71) Applicant: QUALCOMM Incorporated, San Diego, CA (US)

(72) Inventors: Mahdi NAZM BOJNORDI, San Diego, CA (US); Paul Nicholas WHATMOUGH, Cambridge, MA (US)

(21) Appl. No.: 19/170,023

(22) Filed: Apr. 3, 2025

(51) Int. Cl. G06F 12/02

(52) U.S. Cl. CPC G06F 12/023

(57) ABSTRACT

A data processing method includes identifying bandwidth-critical data. The method also includes allocating a region of address space of off-chip memory to a stage buffer in on-chip memory. The method further includes detecting a first memory read of a data block of the bandwidth-critical data, which is stored in the off-chip memory. The method still further includes copying the data block to the stage buffer in response to detecting the first memory read of the data block. The method also includes updating a stage record to indicate the copying. The method also includes accessing the data block in the stage buffer in response to a subsequent memory read of the data block.

### BACKGROUND

### Field

Aspects of the present disclosure relate to computing devices, and more specifically to buffering bandwidth-critical data for efficiency.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

Storing data outside of an SoC device or core device (e.g., off-chip) saves space in the chip of the processing device, but incurs latency when moving the data back and forth between the off-chip memory and the processor. Memory buffers, such as a data cache, may temporarily store data to reduce latency. However, data caches may not be appropriate for some types of memory. It would be desirable to improve data movement latency for bandwidth-critical data.

### SUMMARY

In aspects of the present disclosure, a method for data processing includes identifying bandwidth-critical data. The method also includes allocating a region of off-chip memory address space to a stage buffer located in on-chip memory. The method further includes detecting a first memory read of a data block of the bandwidth-critical data, which is stored in the off-chip memory. The method still further includes copying the data block to the stage buffer in response to detecting the first memory read of the data block. The method also includes updating a stage record to indicate the copying. The method also includes accessing the data block in the stage buffer in response to a subsequent memory read of the data block.

Other aspects of the present disclosure are directed to an apparatus. The apparatus has one or more memories and one or more processors coupled to the one or more memories. The processor(s) is configured to identify bandwidth-critical data. The processor(s) is also configured to allocate a region of address space of off-chip memory to a stage buffer in on-chip memory. The processor(s) is further configured to detect a first memory read of a data block of the bandwidth-critical data, which is stored in the off-chip memory. The processor(s) is still further configured to copy the data block to the stage buffer in response to detecting the first memory read of the data block. The processor(s) is also configured to update a stage record to indicate the copying. The processor(s) is configured to access the data block in the stage buffer in response to a subsequent memory read of the data block.

In other aspects of the present disclosure, a non-transitory computer-readable medium with program code recorded thereon is disclosed. The program code is executed by a processor and includes program code to identify bandwidth-critical data. The program code also includes program code to allocate a region of address space of off-chip memory to a stage buffer in on-chip memory. The program code further includes program code to detect a first memory read of a data block of the bandwidth-critical data, which is stored in the off-chip memory. The program code still further includes program code to copy the data block to the stage buffer in response to detecting the first memory read of the data block. The program code also includes program code to update a stage record to indicate the copying. The program code includes program code to access the data block in the stage buffer in response to a subsequent memory read of the data block.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a buffer for bandwidth-critical data, in accordance with certain aspects of the present disclosure.

FIG. 2 is a block diagram of a matrix multiply operation, in accordance with various aspects of the present disclosure.

FIG. 3 is a block diagram illustrating kernel mapping, in accordance with various aspects of the present disclosure.

FIG. 4 is a block diagram illustrating data staging, in accordance with various aspects of the present disclosure.

FIG. 5 is a diagram illustrating buffer designation, in accordance with various aspects of the present disclosure.

FIG. 6 is a diagram illustrating monitoring of dynamic random access memory (DRAM) read operations, in accordance with various aspects of the present disclosure.

FIG. 7 is a diagram illustrating copy and bookkeeping operations, in accordance with various aspects of the present disclosure.

FIG. 8 is a table illustrating modes of a stage controller, in accordance with various aspects of the present disclosure.

FIG. 9 is a table illustrating discard operations, in accordance with various aspects of the present disclosure.

FIG. 10 is a diagram illustrating on-chip data access, in accordance with various aspects of the present disclosure.

FIG. 11 is a table for block hits, in accordance with various aspects of the present disclosure.

FIG. 12 is a flow diagram illustrating an example process performed, for example, by a computing device, in accordance with various aspects of the present disclosure.

FIG. 13 is a block diagram showing an exemplary wireless communications system in which a configuration of the present disclosure may be advantageously employed.

FIG. 14 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Storing data outside of an SoC device or core device (e.g., off-chip) saves space in the chip of a processing device, but incurs latency when moving the data back and forth between the off-chip memory and a processor. Memory buffers, such as a data cache, may temporarily store data to reduce latency. However, data caches may not be appropriate for some types of memory. It would be desirable to improve data movement latency for bandwidth-critical data.

Certain data may be characterized as bandwidth-critical data. Bandwidth-critical data significantly limits performance, especially in data-intensive applications. Bandwidth-critical data is read-only data that is low reuse data and is marked by a programmer as non-cacheable data. The programmer may mark certain data as non-cacheable because the programmer believes the data would not benefit from being stored in a cache, for example, due to the large size of the data. In some aspects, the data is too large to fit in a cache, but the data may also be deemed non-cacheable, even if the data has a size that fits within a cache. Thus, bandwidth-critical data has low operational intensity, making the data memory-bound, and causing memory bandwidth to become a performance bottleneck due to the latency involved with transferring the data between the processing unit and off-chip memory.

Aspects of the present disclosure introduce techniques for processing bandwidth-critical data. The new techniques are suitable for a variety of systems-on-a chip (SoCs) from mobile devices and laptops to servers. Aspects of the present disclosure introduce a hardware managed on-chip buffering mechanism for bandwidth-critical data. The main components of the proposed solution include buffer designation and data staging. For buffer designation, two main tasks occur at the software level. First, it is determined which data is bandwidth-critical in the software. Next, buffering regions are allocated to assign the identified bandwidth-critical data to specific stage buffering regions. With data staging, three main tasks are performed in hardware for staging at runtime. Every read operation from off-chip memory, such as dynamic random access memory (DRAM), is monitored. Copy and bookkeeping operations are then performed. Finally, on-chip data access from the staging memory occurs.

Particular aspects of the subject matter described in this disclosure can be implemented to realize one or more of the following potential advantages. In some examples, the described techniques, such as buffering bandwidth-critical data, enables power savings and reduces latency with memory access operations.

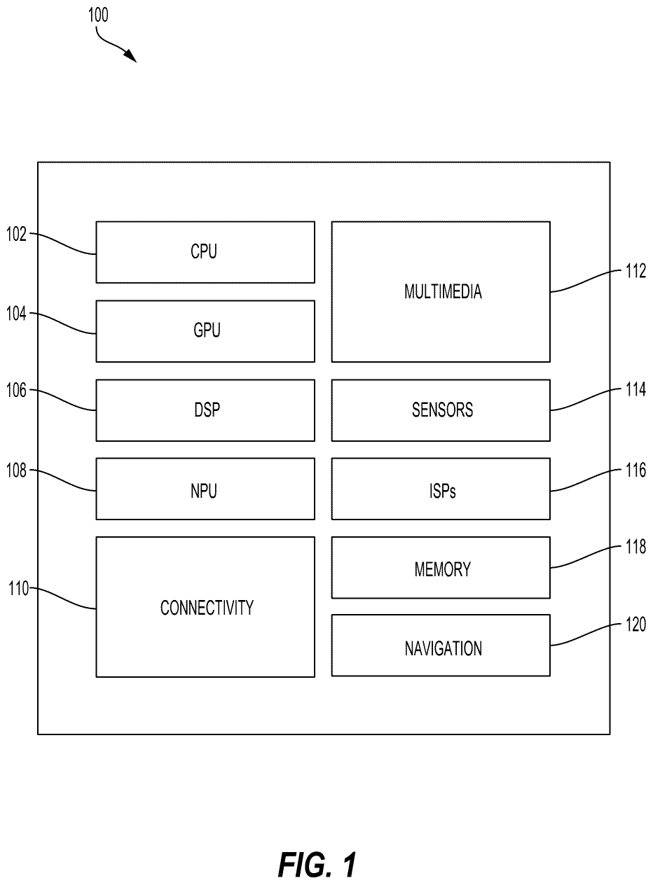

FIG. 1 illustrates an example implementation of a host system-on-a-chip (SoC) 100, which includes a buffer for bandwidth-critical data, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

According to aspects of the present disclosure, a computing device includes a bandwidth-critical data buffering system. The bandwidth-critical data buffering system may include means for identifying, means for allocating, means for detecting, means for copying, means for updating, means for accessing, means for partitioning, means for comparing, means for resetting, and means for discarding. In one configuration, the identifying means, allocating means, detecting means, copying means, updating means, accessing means, partitioning means, comparing means, resetting means, and discarding means may be the CPU 102, GPU 104, DSP 106, NPU 108, stage controller, 738, and/or controller 512, 612 as shown in FIGS. 1, 5, 6, 7, and 10. In other aspects, the aforementioned means may be any structure or any material configured to perform the functions recited by the aforementioned means.

Storing data off-chip saves space in a processing device, but incurs latency when moving the data back and forth between the off-chip memory and the processor. Memory buffers, such as a data cache, may temporarily store data to reduce latency. However, data caches may not be appropriate for some types of memory.

Certain data may be characterized as bandwidth-critical data. Bandwidth-critical data significantly limits performance, especially in data-intensive applications. Bandwidth-critical data is read-only data that is low reuse data and is marked by a programmer as non-cacheable data. The programmer may mark certain data as non-cacheable because the programmer believes the data would not benefit from being stored in a cache, for example, due to the large size of the data. In some aspects, the data is too large to fit in a cache, but the data may be deemed non-cacheable, even if the data has a size that fits within a cache.

Conventional caching may be ineffective not only due to the large data size but also because of the low reuse level. Low reuse data is data that is accessed only a few times during computation. Low reuse data can cause cache pollution, impacting the performance of cache-friendlier data. Thus, bandwidth-critical data has low operational intensity, making the data memory-bound, and causing memory bandwidth to become a performance bottleneck due to the latency involved with transferring the data between the processing unit and off-chip memory. Stated another way, bandwidth-critical data refers to data that is a large amount of data that is infrequently accessed for computation.

Bandwidth-critical data may be used in various scientific and artificial intelligence (AI) workloads. Model weights for an artificial intelligence/machine learning (AI/ML) model are an example of low reuse bandwidth-critical data. Such bandwidth-critical data restricts the performance of AI workloads, such as large language models. AI workloads span various fields, including machine learning, deep learning, natural language processing, computer vision, and generative AI, all of which demand efficient data handling. For instance, large language models are becoming increasingly data-intensive, specifying significant bandwidth for optimal performance. Today, model sizes have increased significantly, with some models exceeding 70 billion parameters. Weight data used in matrix multiplications, a core operation for AI workloads, is particularly bandwidth-critical, impacting efficiency and performance.

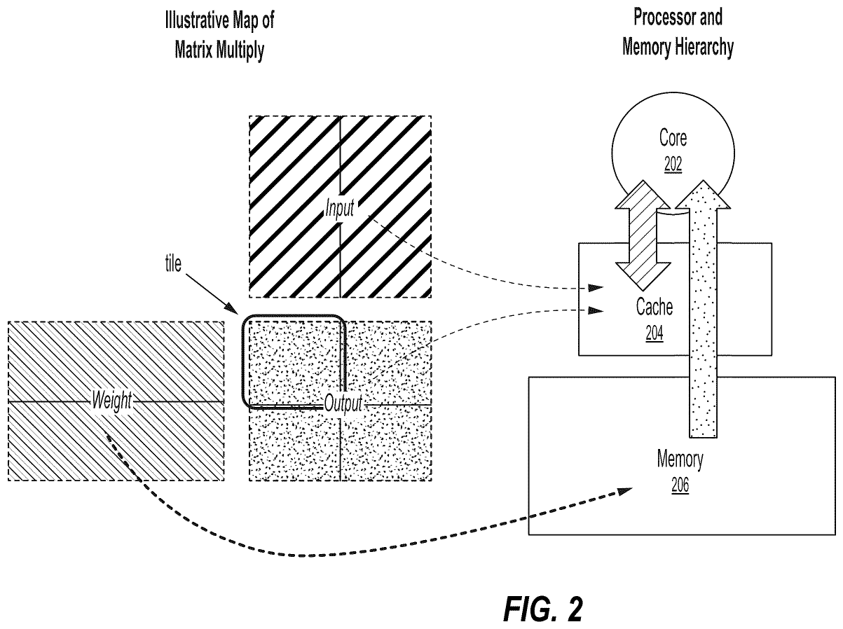

FIG. 2 is a block diagram of a matrix multiply operation, in accordance with various aspects of the present disclosure. In the example of FIG. 2, a processing core 202 performs a matrix multiply operation, which is a common operation for AI workloads. The processing core 202 accesses three types of data during the matrix multiply operation. Input data is generated by a predecessor operation, and stored and accessed from a cache 204 during the matrix multiply operation. Output data is locally generated and may be stored and accessed from the cache 204 multiple times during computation. Weight data is precomputed during a training phase and streamed from off-chip main memory 206 to complete the operation.

Not all data benefits from being placed in the cache. Unlike input and output data, weights initially reside in the main memory 206. Caching weights can lead to conflicts and eviction of input/output data. Caching weights increases access time and maintenance costs.

In practice, the processing core 202 can only perform one tile of computation at a time due to the limited capacity of the processing core 202. Tiling may necessitate multiple accesses to input or weight data. While input/output data benefits from caching, weights need another type of efficient buffering because large data sizes and low reuse rates lead to inefficient cache utilization, causing frequent evictions and replacements. Explicit software management of scratchpad memory introduces additional latency, slowing data retrieval and processing. There is a need for efficient use of on-chip memory, especially in bandwidth-stringent SoCs.

Aspects of the present disclosure introduce techniques for processing bandwidth-critical data. The new techniques are suitable for a variety of SoCs from mobile devices and laptops to servers. Both cache and scratchpad memory architectures can benefit from these new techniques that provide energy efficiency and improved performance of bandwidth-critical data processing. In particular, benefits are seen when processing large models with substantial weight data.

As noted, conventional on-chip memories encounter efficiency challenges when processing bandwidth-critical data. Moreover, the amount of bandwidth-critical data is growing (e.g., with AI workloads), preventing current systems from efficiently handling this type of data.

Aspects of the present disclosure introduce a hardware managed on-chip buffering mechanism for bandwidth-critical data. The main components of the proposed solution include buffer designation and data staging.

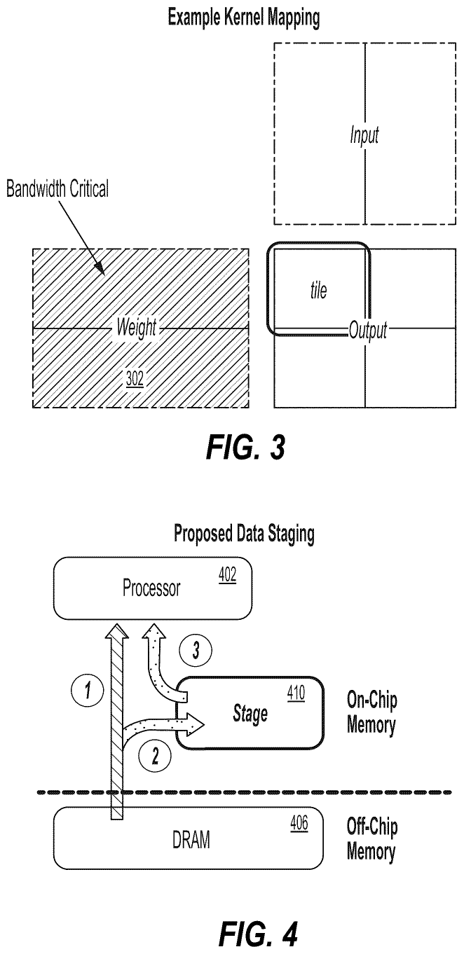

FIG. 3 is a block diagram illustrating kernel mapping, in accordance with various aspects of the present disclosure. For buffer designation, two main tasks occur at the software level. First, it is determined which data is bandwidth-critical in the software. Such a designation occurs at coding time or when recognizing the data is bandwidth-critical during runtime. The bandwidth-critical data can be determined based on tensor shapes, such as the size of a weights matrix. As seen in the example of FIG. 3, weights 302 in a matrix multiply kernel are potential bandwidth-critical data.

Buffer designation also includes the task of allocating buffering regions, which assigns the identified bandwidth-critical data to specific stage buffering regions. A particular system call or a modified memory allocation (malloc) function may allocate a buffer in a stage memory.

FIG. 4 is a block diagram illustrating data staging, in accordance with various aspects of the present disclosure. With data staging, three main tasks are performed in hardware for staging at runtime. Data staging improves performance and power efficiency of the processing operation. As seen in the example of FIG. 4, at step 1, every read operation from off-chip memory, such as dynamic random access memory (DRAM) 406, is monitored. More specifically, non-cacheable reads by a processor 402 from the DRAM 406 are identified in order to detect accesses to a designated stage buffering region 410. At step 2, copy and bookkeeping operations are performed. That is, the system silently copies the accessed data block in DRAM 406 to the staging memory in the stage buffering region 410 and updates the necessary records. At step 3, on-chip data access from the staging memory in the stage buffering region 410 occurs. More specifically, for subsequent accesses to the recorded data, the data is read from the stage memory in the stage buffering region 410 instead of the off-chip DRAM 406.

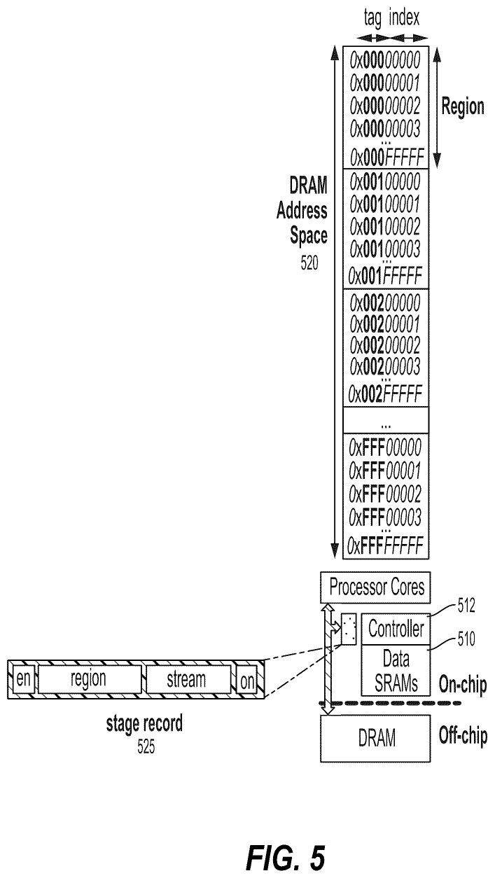

Buffer designation is now described in more detail with reference to FIG. 5, which is a diagram illustrating buffer designation, in accordance with various aspects of the present disclosure. As seen in the example of FIG. 5, buffer designation includes changes to a controller 512 of an on-chip memory (e.g., data static random access memory (SRAM) 510). The changes to the controller 512 enable repurposing an on-chip cache and/or scratchpad memory as a stage buffer. Scratchpad memory may be repurposed as a stage buffer with modifications to the controller 512. A cache may be repurposed as a stage buffer with an additional operational mode to bypass tag access and directly access the data arrays. In other implementations, a new SRAM 510 may be defined as the stage buffer, instead of repurposing existing SRAM 510.

Software defines buffer regions and allocates data in a stage memory. The buffer designation process includes partitioning a DRAM address space 520 into multiple regions, with only one region assigned to the stage buffer at any time. The size of the designated regions depends on a size available within the SRAM 510. Partitioning is achieved via address bit selection (e.g., tag and index), as shown in FIG. 5. The operating system (OS) maps a region of the address space 520 to the stage buffer by writing the tag of the region into a designated register (e.g., region) and setting an enable flag (e.g., EN) within a stage record 525. The stage record 525 is within the controller 512 and includes two registers (stream and region registers) and two flags (EN and ON). The EN flag indicates where the stage cache functionality is active. The region register is visible to software. The stream register and ON flag indicate whether a current substage is being accessed, in terms of memory blocks of a substage. Both the EN and ON flags are initially set to 0.

A workload accesses memory blocks in a streamed fashion, such that the data is streamed block by block from the memory. Any data allocated within the designated region may be accessed via the proposed stage buffering. The state of all tables and registers of the stage hardware is reset on a region update.

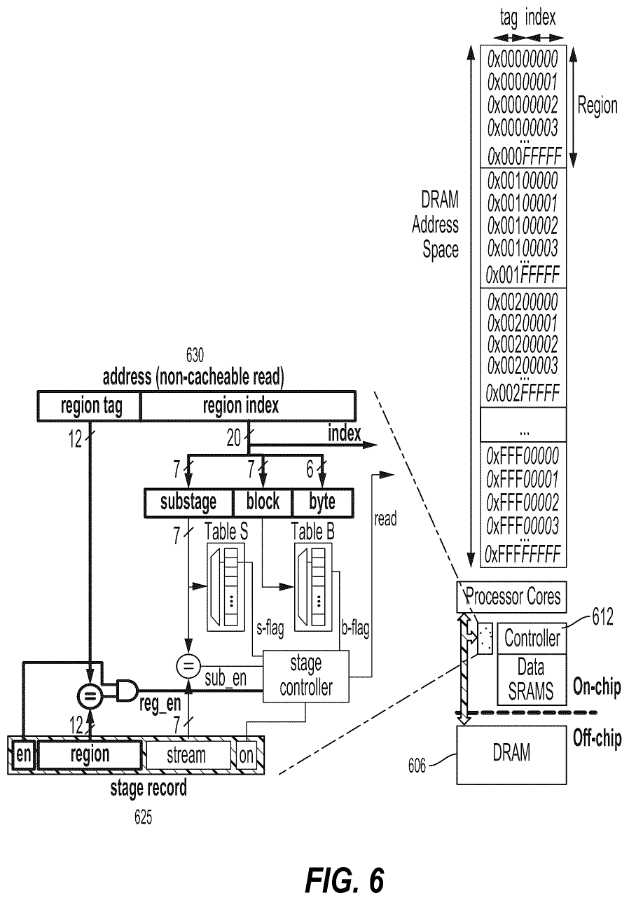

Monitoring DRAM reads for data staging is now described in more detail with respect to FIG. 6. FIG. 6 is a diagram illustrating monitoring of DRAM read operations, in accordance with various aspects of the present disclosure. A controller 612 monitors DRAM read operations during runtime. The controller 612 tracks non-cacheable reads from DRAM 606 to detect accesses to a designated stage buffering region. An address 630 of every non-cacheable read to DRAM 606 is partitioned to a region tag and a region index. The controller 612 compares the region tag of the address 630 against the region of a stage record 625 to determine if the current region is being accessed. If a match occurs (indicating access), the controller 612 generates a binary region enable (reg_en) signal.

The region index of the address 630 is used for reading or writing data blocks in a stage buffer. A designated stage buffer comprises a hierarchy of substages, blocks, and bytes. The region index generates the addressing value for each component. The substage addressing value is the identifier (ID) of a substage within the stage buffer. The block addressing value is the address of a block accessed in the stage buffer. The byte addressing value is the byte offset within each accessed block.

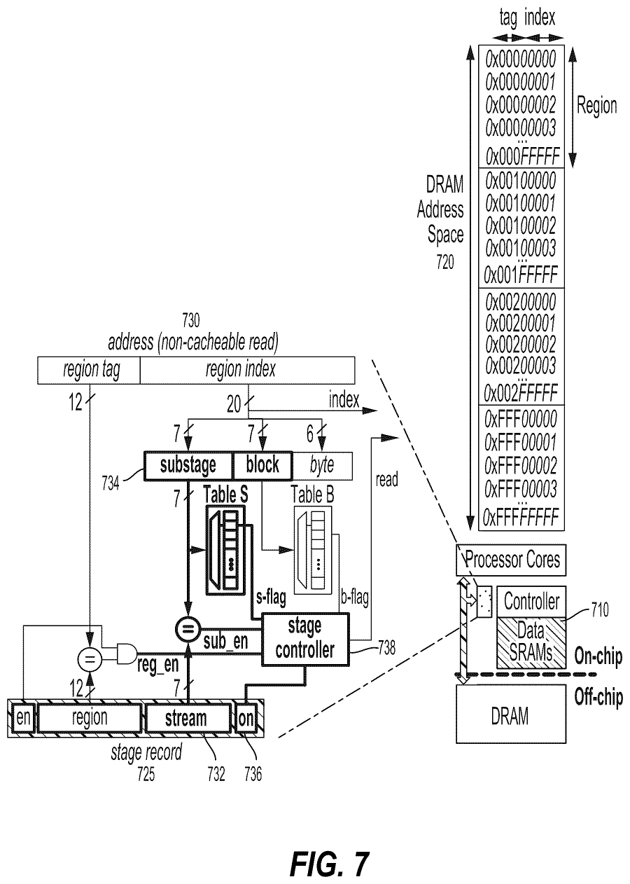

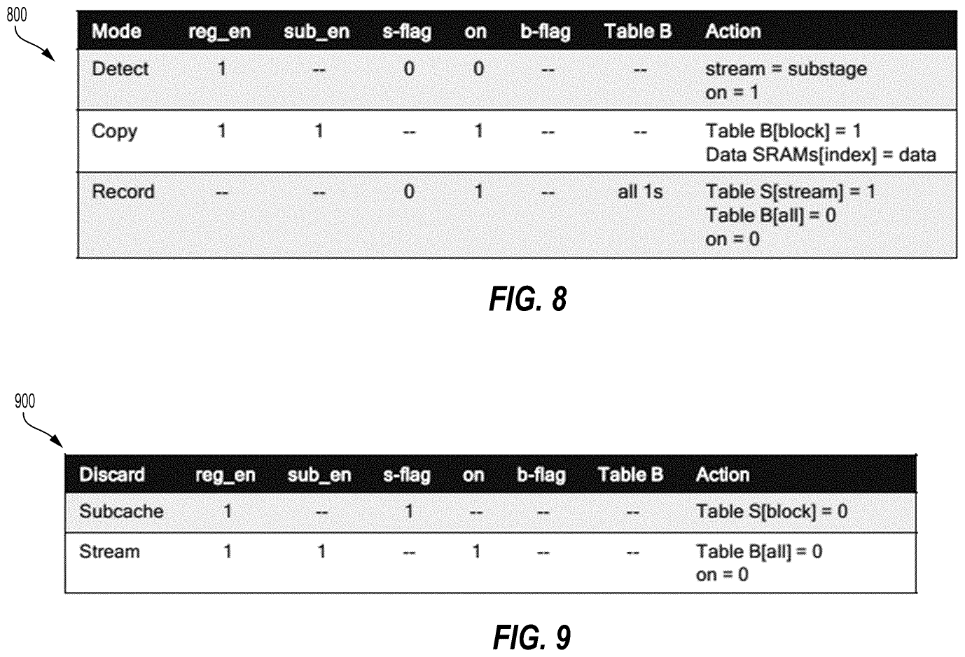

Determining when to copy data from DRAM into an SRAM stage buffer is now described with respect to FIGS. 7-9. FIG. 7 is a diagram illustrating copy and bookkeeping operations, in accordance with various aspects of the present disclosure. FIG. 8 is a table 800 illustrating modes of a stage controller, in accordance with various aspects of the present disclosure. FIG. 9 is a table 900 illustrating discard operations, in accordance with various aspects of the present disclosure.

As seen in the example of FIG. 7, a stage controller 738 detects and records a read stream to a designated region in an internal buffer of an SRAM 710. Each detected stream is stored in a substage of the internal buffer.

Content in a stream register 732 of a stage record 725 is compared with a value of a substage 734 of a region index in a non-cacheable read address 730. If a match occurs, then a substage enable (sub_en) signal is generated. In response to the substage enable signal, a register enable (reg_en) signal, and an ON flag 736, the stage controller 738 activates. The ON flag 736 indicates the system has already allocated buffer space for staging.

The value of the substage 734 is also used as an index into Table S, which outputs a flag (s-flag) to the stage controller 738 to perform copying and bookkeeping for the internal state of the mechanism. Table S is a binary table where every entry is a one bit flag that indicates whether an entire substage has been recorded previously in the stage buffer. That is, the recorded streams are tracked in Table S, where each element of the table indicates whether its corresponding stream is stored in a substage.

The table 800 of FIG. 8 illustrates three different modes for the stage controller 738 of FIG. 7: detect, copy, and record. Each mode is entered when the region enable signal (reg_en) is generated. Detect mode occurs in response to both the s-flag from Table S and the ON flag 736 having values of 0. The value of 0 for the ON flag indicates no streaming is ongoing and the s-flag value of 0 indicates that non-cacheable read access occurring in this region has not yet been recorded. In the detect mode, the ON flag 736 is set to one (on=1) and the value of the substage 734 is stored in the stream register 732 (stream=substage), indicating a first access to that substage. In other words, a substage that is part of the entire region of the DRAM address space 720 is being accessed by the software and a stream access to the substage is expected, which access should be recorded. Consequently, future accesses to the stream are recorded in Table B, indicating which block of the current substage or stream is being recorded. Once all blocks of a substage are recorded, as indicated in Table B, then a bit for that entire substage in Table S is set to one.

The copy mode is entered in response to the ON flag having a value of one, the stream register 732 having the value in the substage 734 (which asserts the sub_en signal), and Table B being empty. All entries in Table B are initially empty. When the copy operation begins, the flag for that block in Table B (Table B[block]) is set to one, confirming the copying of that block. Using the region index of the non-cacheable read address 730 as an index into the SRAM 710, the data is copied into the SRAM 710 (Data SRAMs[index]=data). The copy operation repeats until all elements in Table B are set to one, which triggers the record mode.

In the record mode, all the bits in Table B are set to one. Thus, the flag in Table S corresponding to the stream register 732 is set to one (Table S[stream]=1), indicating the entire substage has been recorded. Table B is reset to 0 (Table B[all]=0) and the ON flag is set to 0 (on=0) because streaming is complete. The process then returns to detect mode for the next substage.

In case of a write access or a cacheable access to a region, a discard operation occurs, for example, as seen in the table 900 of FIG. 9. More specifically, a subcache or stream may be discarded. The reg_en signal indicates an access to the region. If the s-flag is one then the values in Table S are reset (Table S[block]=0), discarding the subcache due to the unwanted access to the region. If the sub_en signal and the ON signals are both one, then Table B is reset (Table B[all]=0) and the ON flag is set to 0 (on=0), thus, discarding the stream due to the unwanted access to the region.

It is noted that Table S and Table B are both reset to 0 when a core operation completes a computation and the operating system allocates a new buffer designation for a next core operation.

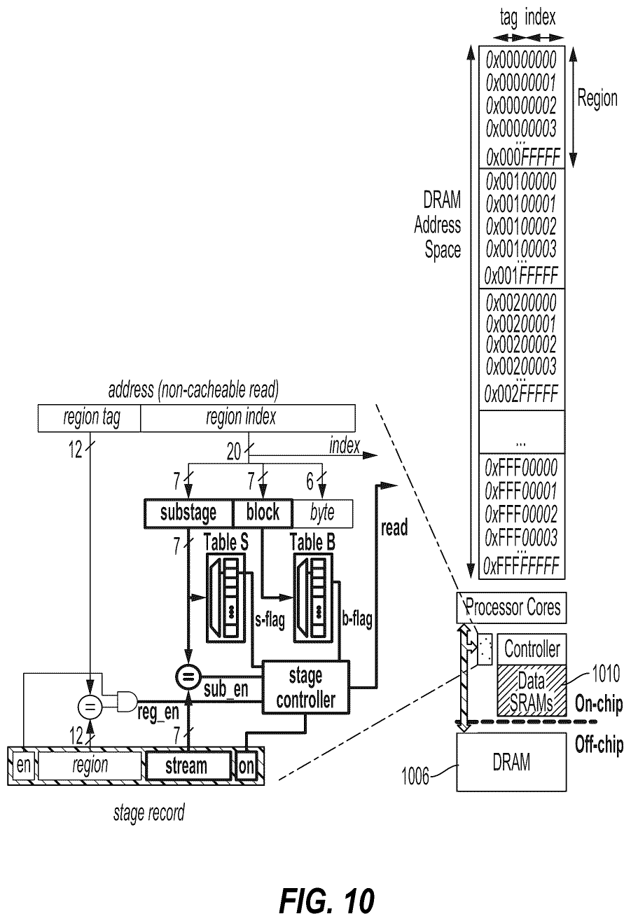

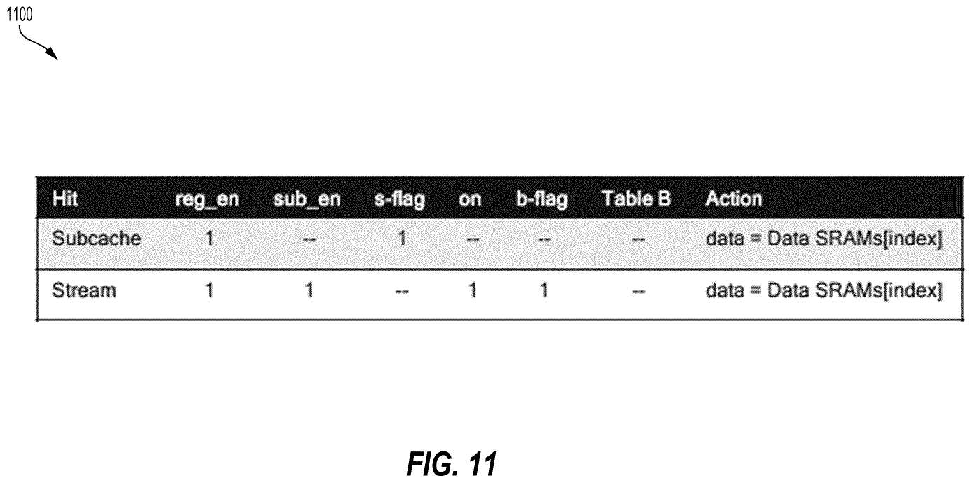

On-chip data access in the data staging process is now described with respect to FIGS. 10 and 11. FIG. 10 is a diagram illustrating on-chip data access, in accordance with various aspects of the present disclosure. FIG. 11 is a table 1100 for block hits, in accordance with various aspects of the present disclosure. As seen in the examples of FIGS. 10 and 11, accessing stage blocks is supported for both recorded subcaches and an ongoing stream. Two types of block hits are possible for a designated stage. With a subcache hit (based on Table S), a data block belongs to a recorded subcache in on-chip SRAM 1010. With a stream hit (based on Table B), a block of data is stored in SRAM 1010 as part of a current stream. On a stage hit, data is read from the on-chip SRAM, eliminating the need for DRAM access.

As seen in the table 1100 of FIG. 11, for a subcache hit when reg_en is one and s-flag is one, the data is retrieved from the SRAM 1010 in accordance with the region index (data =Data SRAMs[index]), instead of being retrieved from DRAM 1006. This occurs when the ON flag is 0 (shown as ‘-’), indicating that a stream is not currently occurring. The s-flag value of one indicates that the region being accessed was previously recorded in the SRAM 1010.

If streaming is on (on=1) and reg_en, sub_en, and b-flag all have values of one, then a stream hit occurred. With a stream hit, the data is retrieved from the SRAM in accordance with the region index (data =Data SRAMs[index]), instead of being retrieved from the DRAM 1006. A b-flag value of one indicates that the block is part of the current stream and the data is already recorded.

The stage buffering solution of the present disclosure addresses power and performance limitations of processing bandwidth-critical data. Memory mapped registers enable software to map a DRAM address space to on-chip SRAM for efficient data staging. Controller modifications update the on-chip cache and scratchpad memory controllers to support stage buffers and bypass cache tag checks. A hardware controller implementation detects bandwidth-critical data streams, records the data in stage buffers, and provides faster, more energy efficient access, reducing dependency on main memory. Stream management discards recorded streams upon unexpected writes or cacheable accesses to maintain memory and stage consistency.

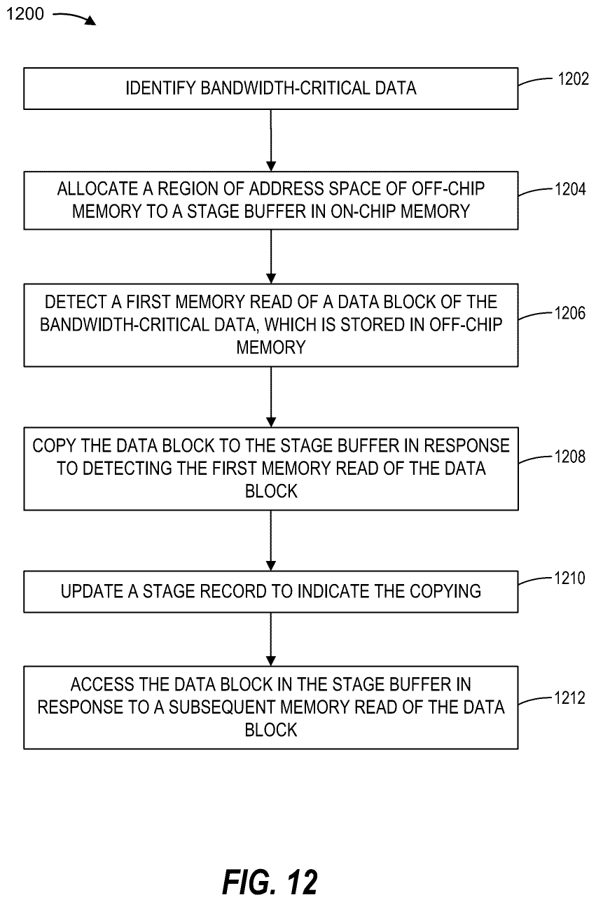

FIG. 12 is a flow diagram illustrating an example process 1200 performed, for example, by a computing device, in accordance with various aspects of the present disclosure. The example process 1200 is an example of buffering bandwidth-critical data.

As shown in FIG. 12, in some aspects, the process 1200 may include identifying bandwidth-critical data (block 1202). In some aspects, the process 1200 may include allocating a region of address space of off-chip memory to a stage buffer in on-chip memory (block 1204). Each region of the address space of off-chip memory may be divided into multiple substages and a first table may indicate whether an entire substage has been recorded in the stage buffer. In some aspects, the allocating includes partitioning an address space of off-chip memory into multiple regions of the address space; and allocating the region of the address space to the stage buffer by writing tags corresponding to the region of the address space into a register of the stage record.

In some aspects, the process 1200 may include detecting a first memory read of a data block of the bandwidth-critical data, which is stored in the off-chip memory (block 1206). For example, the detecting may include comparing a region tag from an address of a non-cacheable read with a region stored in the stage record.

In some aspects, the process 1200 may include copying the data block to the stage buffer in response to detecting the first memory read of the data block (block 1208). In some aspects, the process 1200 may include updating a stage record to indicate the copying (1210). The process 1200 may also include accessing the data block in the stage buffer in response to a subsequent memory read of the data block (block 1212).

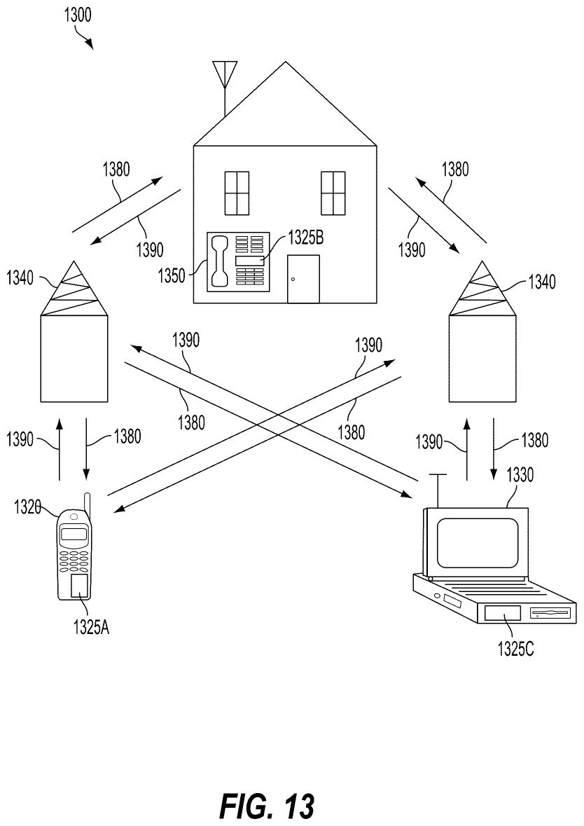

FIG. 13 is a block diagram showing an exemplary wireless communications system 1300, in which an aspect of the present disclosure may be advantageously employed. For purposes of illustration, FIG. 13 shows three remote units 1320, 1330, and 1350, and two base stations 1340. It will be recognized that wireless communications systems may have many more remote units and base stations. Remote units 1320, 1330, and 1350 include integrated circuit (IC) devices 1325A, 1325B, and 1325C that include the disclosed buffer for bandwidth-critical data. It will be recognized that other devices may also include the disclosed buffer for bandwidth-critical data such as the base stations, switching devices, and network equipment. FIG. 13 shows forward link signals 1380 from the base stations 1340 to the remote units 1320, 1330, and 1350, and reverse link signals 1390 from the remote units 1320, 1330, and 1350 to the base stations 1340.

In FIG. 13, remote unit 1320 is shown as a mobile telephone, remote unit 1330 is shown as a portable computer, and remote unit 1350 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 13 illustrates remote units according to the aspects of the present disclosure, the disclosure is not limited to these exemplary illustrated units. Aspects of the present disclosure may be suitably employed in many devices, which include the disclosed buffer for bandwidth-critical data.

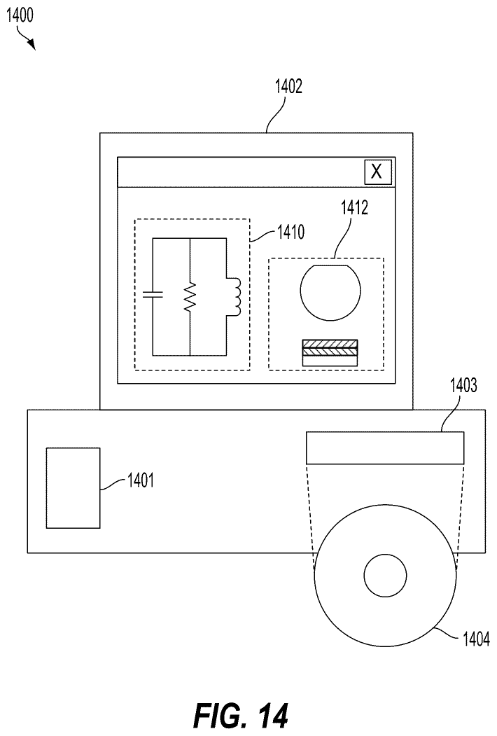

FIG. 14 is a block diagram illustrating a design workstation 1400 used for circuit, layout, and logic design of a semiconductor component, such as the buffer for bandwidth-critical data disclosed above. The design workstation 1400 includes a hard disk 1401 containing operating system software, support files, and design software such as Cadence or OrCAD. The design workstation 1400 also includes a display 1402 to facilitate design of a circuit 1410 or a semiconductor component 1412, such as the buffer for bandwidth-critical data. A storage medium 1404 is provided for tangibly storing the design of the circuit 1410 or the semiconductor component 1412 (e.g., the PLD). The design of the circuit 1410 or the semiconductor component 1412 may be stored on the storage medium 1404 in a file format such as GDSII or GERBER. The storage medium 1404 may be a CD-ROM, DVD, hard disk, flash memory, or other appropriate device. Furthermore, the design workstation 1400 includes a drive apparatus 1403 for accepting input from or writing output to the storage medium 1404.

Data recorded on the storage medium 1404 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1404 facilitates the design of the circuit 1410 or the semiconductor component 1412 by decreasing the number of processes for designing semiconductor wafers.

### Example Aspects

Aspect 1: A data processing method, comprising: identifying bandwidth-critical data; allocating a region of address space of off-chip memory to a stage buffer in on-chip memory; detecting a first memory read of a data block of the bandwidth-critical data, which is stored in the off-chip memory; copying the data block to the stage buffer in response to detecting the first memory read of the data block; updating a stage record to indicate the copying; and accessing the data block in the stage buffer in response to a subsequent memory read of the data block.
Aspect 2: The method of aspect 1, in which the allocating comprises: partitioning an address space of the off-chip memory into a plurality of regions of the address space; and allocating the region of the address space to the stage buffer by writing tags corresponding to the region of the address space into a register of the stage record.
Aspect 3: The method of aspect 1 or 2, in which the detecting comprises comparing a region tag from an address of a non-cacheable read with a region stored in the stage record.
Aspect 4: The method of any of the preceding aspects, in which each region of the address space of the off-chip memory is divided into a plurality of substages and a first table indicates whether an entire substage has been recorded in the stage buffer.
Aspect 5: The method of any of the preceding aspects, in which each substage is divided into a plurality of blocks and a second table tracks access of blocks within a currently recording stream.
Aspect 6: The method of any of the preceding aspects, further comprising resetting the second table and updating a flag in the first table in response to an entire stream being recorded.
Aspect 7: The method of any of the preceding aspects, further comprising discarding a recorded stream or a recorded substage in response to detecting a write to the region or a cacheable access to the region.
Aspect 8: An apparatus for data processing, comprising: at least one memory; and at least one processor coupled to the at least one memory, the at least one processor configured: to identify bandwidth-critical data; to allocate a region of address space of off-chip memory to a stage buffer in on-chip memory; to detect a first memory read of a data block of the bandwidth-critical data, which is stored in the off-chip memory; to copy the data block to the stage buffer in response to detecting the first memory read of the data block; to update a stage record to indicate the copying; and to access the data block in the stage buffer in response to a subsequent memory read of the data block.
Aspect 9: The apparatus of aspect 8, in which the at least one processor is further configured: to partition an address space of the off-chip memory into a plurality of regions of the address space; and to allocate the region of the address space to the stage buffer by writing tags corresponding to the region of the address space into a register of the stage record.
Aspect 10: The apparatus of aspect 8 or 9, in which the at least one processor is further configured to compare a region tag from an address of a non-cacheable read with a region stored in the stage record.
Aspect 11: The apparatus of any of aspects 8-10, in which each region of the address space of the off-chip memory is divided into a plurality of substages and a first table indicates whether an entire substage has been recorded in the stage buffer.
Aspect 12: The apparatus of any of aspects 8-11, in which each substage is divided into a plurality of blocks and a second table tracks access of blocks within a currently recording stream.
Aspect 13: The apparatus of any of aspects 8-12, in which the at least one processor is further configured to reset the second table and updating a flag in the first table in response to an entire stream being recorded.
Aspect 14: The apparatus of any of aspects 8-13, in which the at least one processor is further configured to discard a recorded stream or a recorded substage in response to detecting a write to the region or a cacheable access to the region.
Aspect 15: A non-transitory computer-readable medium having program code recorded thereon, the program code executed by a processor and comprising: program code to identify bandwidth-critical data; program code to allocate a region of address space of off-chip memory to a stage buffer in on-chip memory; program code to detect a first memory read of a data block of the bandwidth-critical data, which is stored in the off-chip memory; program code to copy the data block to the stage buffer in response to detecting the first memory read of the data block; program code to update a stage record to indicate the copying; and program code to access the data block in the stage buffer in response to a subsequent memory read of the data block.
Aspect 16: The non-transitory computer-readable medium of aspect 15, in which the program code comprises: program code to partition an address space of the off-chip memory into a plurality of regions of the address space; and program code to allocate the region of the address space to the stage buffer by writing tags corresponding to the region of the address space into a register of the stage record.
Aspect 17: The non-transitory computer-readable medium of aspect 15 or 16, in which the program code comprises program code to compare a region tag from an address of a non-cacheable read with a region stored in the stage record.
Aspect 18: The non-transitory computer-readable medium of any of aspects 15-17, in which each region of the address space of the off-chip memory is divided into a plurality of substages and a first table indicates whether an entire substage has been recorded in the stage buffer.
Aspect 19: The non-transitory computer-readable medium of any of aspects 15-18, in which each substage is divided into a plurality of blocks and a second table tracks access of blocks within a currently recording stream.
Aspect 20: The non-transitory computer-readable medium of any of aspects 15-19, in which the program code comprises program code to reset the second table and updating a flag in the first table in response to an entire stream being recorded.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A data processing method, comprising:
identifying bandwidth-critical data;
allocating a region of address space of off-chip memory to a stage buffer in on-chip memory;
detecting a first memory read of a data block of the bandwidth-critical data, which is stored in the off-chip memory;
copying the data block to the stage buffer in response to detecting the first memory read of the data block;
updating a stage record to indicate the copying; and
accessing the data block in the stage buffer in response to a subsequent memory read of the data block.

2. The method of claim 1, in which the allocating comprises:
partitioning the address space of the off-chip memory into a plurality of regions of the address space; and
allocating the region of the address space to the stage buffer by writing tags corresponding to the region of the address space into a register of the stage record.

3. The method of claim 1, in which the detecting comprises comparing a region tag from an address of a non-cacheable read with a region stored in the stage record.

4. The method of claim 1, in which each region of the address space of the off-chip memory is divided into a plurality of substages and a first table indicates whether an entire substage has been recorded in the stage buffer.

5. The method of claim 4, in which each substage is divided into a plurality of blocks and a second table tracks access of blocks within a currently recording stream.

6. The method of claim 5, further comprising resetting the second table and updating a flag in the first table in response to an entire stream being recorded.

7. The method of claim 1, further comprising discarding a recorded stream or a recorded substage in response to detecting a write to the region or a cacheable access to the region.

8. An apparatus for data processing, comprising:
at least one memory; and
at least one processor coupled to the at least one memory, the at least one processor configured:
to identify bandwidth-critical data;
to allocate a region of address space of off-chip memory to a stage buffer in on-chip memory;
to detect a first memory read of a data block of the bandwidth-critical data, which is stored in the off-chip memory;
to copy the data block to the stage buffer in response to detecting the first memory read of the data block;
to update a stage record to indicate the copying; and
to access the data block in the stage buffer in response to a subsequent memory read of the data block.

9. The apparatus of claim 8, in which the at least one processor is further configured:
to partition the address space of the off-chip memory into a plurality of regions of the address space; and
to allocate the region of the address space to the stage buffer by writing tags corresponding to the region of the address space into a register of the stage record.

10. The apparatus of claim 8, in which the at least one processor is further configured to compare a region tag from an address of a non-cacheable read with a region stored in the stage record.

11. The apparatus of claim 8, in which each region of the address space of the off-chip memory is divided into a plurality of substages and a first table indicates whether an entire substage has been recorded in the stage buffer.

12. The apparatus of claim 11, in which each substage is divided into a plurality of blocks and a second table tracks access of blocks within a currently recording stream.

13. The apparatus of claim 12, in which the at least one processor is further configured to reset the second table and updating a flag in the first table in response to an entire stream being recorded.

14. The apparatus of claim 8, in which the at least one processor is further configured to discard a recorded stream or a recorded substage in response to detecting a write to the region or a cacheable access to the region.

15. A non-transitory computer-readable medium having program code recorded thereon, the program code executed by a processor and comprising:
program code to identify bandwidth-critical data;
program code to allocate a region of address space of off-chip memory to a stage buffer in on-chip memory;
program code to detect a first memory read of a data block of the bandwidth-critical data, which is stored in the off-chip memory;
program code to copy the data block to the stage buffer in response to detecting the first memory read of the data block;
program code to update a stage record to indicate the copying; and
program code to access the data block in the stage buffer in response to a subsequent memory read of the data block.

16. The non-transitory computer-readable medium of claim 15, in which the program code comprises:
program code to partition the address space of the off-chip memory into a plurality of regions of the address space; and
program code to allocate the region of the address space to the stage buffer by writing tags corresponding to the region of the address space into a register of the stage record.

17. The non-transitory computer-readable medium of claim 15, in which the program code comprises program code to compare a region tag from an address of a non-cacheable read with a region stored in the stage record.

18. The non-transitory computer-readable medium of claim 15, in which each region of the address space of the off-chip memory is divided into a plurality of substages and a first table indicates whether an entire substage has been recorded in the stage buffer.

19. The non-transitory computer-readable medium of claim 18, in which each substage is divided into a plurality of blocks and a second table tracks access of blocks within a currently recording stream.

20. The non-transitory computer-readable medium of claim 19, in which the program code comprises program code to reset the second table and updating a flag in the first table in response to an entire stream being recorded.
